(19) United States
(12) Patent Application Publication
(10) Pub. No.: US 2005/0140831 A1
(43) Pub. Date: Jun. 30, 2005

(54) Projection optical system and projection television employing the same

(75) Inventors: Seok-il Yoon, Daejeon Metropolitan-City (KR); Gyu-hwan Hwang, Hwaseong-si (KR); Alexander Fedorovich Shirankov, Moscow (RU); Vadim Victorovich Pozdnyakov, Moscow (RU); Alexey Mikhailovich Khorokhorov, Moscow (RU); Maxim Evguenyevich Frolov, Moscow (RU)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/976,319

(22) Filed: Oct. 29, 2004

(30) Foreign Application Priority Data
Oct. 30, 2003 (RU) 2003131819

(51) Int. Cl. H04N 5/64

(52) U.S. Cl. 348/744

(57) ABSTRACT

A projection optical system and a projection television employing the same are provided. The projection optical system includes a lens module and an electron beam tube optical module. The lens module includes a plastic power lens and a hybrid lens. The hybrid lens includes a spherical, biconvex, glass lens and an aspheric lens layer formed on at least one face of the spherical lens. The electron beam tube optical module includes a C-shaped aberration correction device, a window, and a coolant disposed between the window and the aberration correction device. Accordingly, the projection television can provide high quality pictures. In addition, it is possible to reduce the manufacturing costs of the projection television.

### BACKGROUND OF THE INVENTION

This application claims the benefit of Russian Patent Application No. 2003131819, filed on Oct. 30, 2003, in the Russian Patent and Trademark Office, the disclosure of which is incorporated herein in its entirety by reference.

### FIELD OF THE INVENTION

The present invention relates to a projection optical system and a projection television (TV) employing the same. More particularly, the present invention relates to a projection optical system having a simplified lens system structure, thus reducing the manufacturing costs and satisfactorily correcting aberration, and to a projection television employing the projection optical system.

### DESCRIPTION OF THE RELATED ART

A conventional projection lens system disclosed in U.S. Pat. No. 5,029,993 magnifies an image formed by a cathode ray tube (CRT) and then projects the magnified image on a screen. FIG. 1 is a diagram illustrating the conventional projection lens system. Referring to FIG. 1, the conventional projection lens system includes a first lens 13 having relatively weak power, a second lens 14 having relatively strong focal power, a third lens 15 having at least one aspheric surface and having relatively weak focal power, and a fourth lens 16 having a concave surface facing toward a screen and having relatively strong power. The first through fourth lenses 13 through 16 are sequentially arranged between the screen and a picture tube face along an optical axis 19.

The conventional projection lens system is divided into a lens module LM and an electron beam tube optical module OM. The lens module LM includes the first through third lenses 13 through 15. The first and second lenses 13 and 14 are power lenses formed of plastic, and the third lens 15 is a power lens formed of glass. The electronic beam tube optical module OM includes the fourth lens 16, which is C-shaped.

The conventional lens system, however, has complicated lens structures. In addition, since the conventional lens system is manufactured through compression molding, the manufacturing costs are high. Specifically, two plastic lenses of the conventional lens system should be formed to have at least one aspheric surface through press molding. In general, plastic lenses are manufactured with smaller tolerances than glass lenses, making it more complicated and costly to manufacture plastic lenses than to manufacture glass lenses.

### SUMMARY OF THE INVENTION

The present invention provides a projection optical system which is less costly to manufacture and which satisfactorily corrects aberration, and a projection TV employing the projection optical system.

According to an aspect of the present invention, there is provided a projection optical system. The projection optical system includes a lens module, which itself comprises a plastic power lens and a hybrid lens. The hybrid lens is comprised of a spherical, biconvex, glass lens, and an aspheric lens layer formed on at least one face of the spherical lens. The projection optical system further includes an electron beam tube optical module, comprising a C-shaped aberration correction device, a window, and a coolant disposed between the window and the aberration correction device.

The aspheric lens layer may be formed of plastic.

The focal power of the hybrid lens may be 95-98% of the focal power of the projection optical system.

Both faces of the spherical lens may be symmetrical.

According to another aspect of the present invention, there is provided a projection TV. The projection TV includes an electron beam tube, which generates a color image and a projection optical system, which magnifies the color image and then projects the magnified color image on a screen. Here, the projection optical system may include a lens module and an electron beam tube optical module. The lens module includes a plastic power lens and a hybrid lens. The hybrid lens is comprised of a spherical, biconvex, glass lens and an aspheric lens layer formed on at least one face of the spherical lens. The electron beam tube optical module includes a C-shaped aberration correction device, a window, and a coolant disposed between the window and the aberration correction device.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional projection lens system disclosed in U.S. Pat. No. 5,029,993;

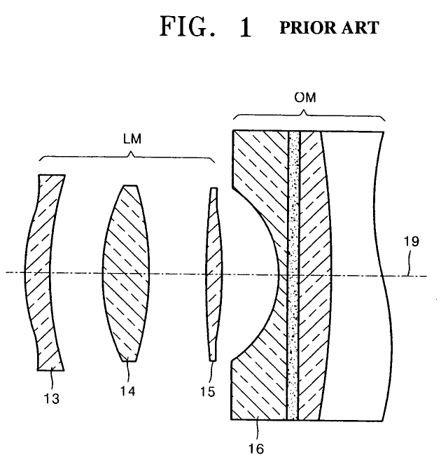

FIG. 2 is a diagram illustrating a projection optical system according to an exemplary embodiment of the present invention; and

FIG. 3 is a diagram illustrating a projection TV employing the projection optical system of FIG. 2, according to an exemplary embodiment of the present invention.

### DETAILED DESCRIPTION OF THE INVENTION

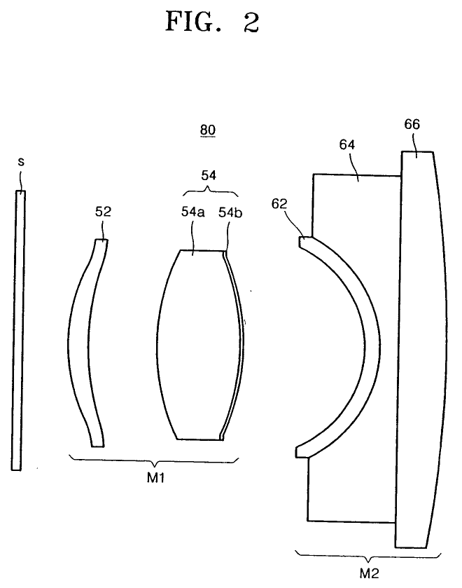

Referring to FIG. 2, a projection optical system 80 includes a lens module M1 and an electron beam tube optical module M2.

The lens module M1 includes a plastic power lens 52 and a hybrid lens 54. The hybrid lens 54 is comprised of a spherical glass lens 54a, which is a biconvex lens, and an aspheric lens layer 54b, which is coated on at least one surface of the spherical glass lens 54a.

Preferably, but not necessarily, both surfaces of the spherical glass lens 54a are symmetrical, and the aspheric lens layer 54b is formed of a plastic layer so that its aspheric surfaces face the electron beam tube optical module M2. The focal power of the hybrid lens 54 has a ratio of 0.95-0.98 to the focal power of the entire projection optical system.

The aspheric lens layer 54b has an aspheric surface expressed by Equation (1):

$$z = \frac{c {ρ}^{2}}{1 + \sqrt{1 - ( 1 + k ) {c}^{2} {ρ}^{2}}} + {\sum }_{i = 1}^{7} {a}_{i} {ρ}^{2 i} \qquad ( 1 )$$

where z denotes a longitudinal coordinate of the aspheric surface, c denotes a curvature of the aspheric surface, p denotes a radial coordinate of the aspheric surface, k denotes a conic constant, and aᵢ denotes an aspheric coefficient, which determines a deviation of the aspheric surface from a spherical surface of the aspheric lens layer 54b and which satisfies the following inequality: ai×aᵢ₊₁<0.

The optical module M2 includes an aberration correction device 62, which is C-shaped, a window 66, and a coolant 64, which is disposed between the aberration correction device 62 and the window 66.

The window 66 covers a fluorescent surface of a display device (e.g., an electron beam tube), which generates a color image. The coolant 64 cools down the display device. The aberration correction device 62, which is in contact with the coolant 64, diverges the color image, generated by the display device, along a predetermined optical path.

A color image output from the aberration correction device 62 is condensed passing through the hybrid lens 54 and then is directed to a screen S after passing through the plastic power lens 52.

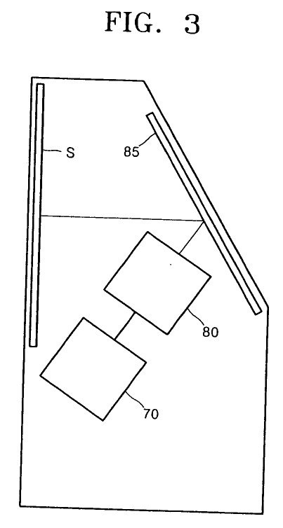

FIG. 3 is a diagram illustrating a projection TV employing the projection optical system 80 of FIG. 2, according to an exemplary embodiment of the present invention. Referring to FIG. 3, the projection TV includes an electron beam tube 70, which generates a color image, and the projection optical system 80, which magnifies the color image and then projects the magnified image on a screen S. The projection TV may further include a mirror 85, which reflects the magnified image output from the projection optical system 80 toward the screen S.

The projection TV forms a color image by combining signals of different color beams (e.g., red, green, and blue beams) generated by the electron beam tube 70 together with the use of the projection optical system 80 and displays the color image on the screen S. The electron beam tube 70 is comprised of three sub-electron beam tubes, which respectively generate, e.g., red, green, and blue images.

As described above with reference to FIG. 2, the projection optical system 80 is divided into the lens module M1 and the electron beam tube optical module M2. Referring to FIG. 2, the plastic power lens 52 has a concave surface facing toward the screen S or the mirror 85 and corrects a spherical aberration that is more likely to be generated as the aperture of the plastic power lens 52 increases.

The hybrid lens 54 is an optical device that magnifies a color image input from the electron beam tube 70. Since the hybrid lens 54 is comprised of the spherical glass lens 54a having a high positive refracting power, and the aspheric lens layer 54b, which is formed on at least one of the surfaces of the spherical glass lens 54a, it can enhance the aberration correctability of the projection optical system.

The aberration correction device 62 is formed of a lens, which has a convex surface facing toward the screen S or the mirror 85 and has a concave surface facing toward the electron beam tube 70, and thus can correct a field curvature and a distortion aberration.

As described above, the projection optical system according to the present invention has a lens module having simplified lens structures and has a reduced number of plastic lenses, thus decreasing the number of press molding processes for generating plastic lenses. In addition, the projection optical system according to the present invention enables a hybrid lens to be manufactured with a high tolerance by forming the hybrid lens to be composed of an aspheric plastic lens layer.

In addition, the projection TV according to the present invention, which employs the projection optical system according to the present invention, can satisfactorily correct a chromatic aberration and spherical aberration. Thus, the projection TV according to the present invention can provide high quality pictures. In addition, since the projection optical system according to the present invention has a reduced number of plastic lenses, the projection TV according to the present invention is less costly to manufacture.

Although the above exemplary embodiments of the present invention have been described, it will be understood by those skilled in the art that the present invention should not be limited to the described exemplary embodiments, but that various changes and modifications can be made within the spirit and scope of the present invention.

1. A projection optical system, comprising:
a lens module, comprising:
a plastic power lens and a hybrid lens, the hybrid lens comprising a spherical, biconvex, glass lens and an aspheric lens layer formed on at least one face of the spherical lens; and
an electron beam tube optical module, comprising:
a C-shaped aberration correction device, a window, and a coolant disposed between the window and the aberration correction device.

2. The projection optical system of claim 1, wherein the aspheric lens layer is formed of plastic.

3. The projection optical system of claim 1, wherein the focal power of the hybrid lens is 95-98% of the focal power of the projection optical system.

4. The projection optical system of claim 1, wherein both faces of the spherical lens are symmetrical.

5. A projection television comprising:
an electron beam tube, which generates a color image; and
a projection optical system, which magnifies the color image and projects the magnified color image on a screen;
wherein the projection optical system comprises:
a lens module, comprising:
a plastic power lens and a hybrid lens, the hybrid lens comprising a spherical, biconvex, glass lens and an aspheric lens layer formed on at least one face of the spherical lens; and
an electron beam tube optical module, comprising:
a C-shaped aberration correction device, a window, and a coolant disposed between the window and the aberration correction device.

6. The projection television of claim 5, wherein the aspheric lens layer is formed of plastic.

7. The projection television of claim 5, wherein the focal power of the hybrid lens is 95-98% of the focal power of the projection optical system.

8. The projection television of claim 5, wherein both faces of the spherical lens are symmetrical.
